(19) United States
(12) Patent Application Publication
(10) Pub. No.: US 2007/0049112 A1
(43) Pub. Date: Mar. 1, 2007

(54) Coaxial cable and method for producing the same

(76) Inventors: Norbert Friese, Taufkirchen (DE); Rolf Goenner, Alternmarkt (DE)

Correspondence Address: KENYON & KENYON LLP, ONE BROADWAY, NEW YORK, NY, 10004, US

(21) Appl. No.: 10/578,112

(22) PCT Filed: Sep. 3, 2004
(86) PCT No.: PCT/EP04/09839

§ 371 Date: May 1, 2006

(30) Foreign Application Priority Data
Oct. 30, 2003 (DE) 103 50 607.1

(51) Int. Cl. H01R 9/05

(52) U.S. Cl. 439/578

(57) ABSTRACT

In a method for producing a concentric coaxial cable and a corresponding coaxial cable, the coaxial cable includes a core, a dielectric enclosing the core, an electroconducting shield enclosing the dielectric, a jacket enclosing the shield, and a connector. The connector includes a contact sleeve which is contacted in a section with the shield in an electroconducting manner. The contact sleeve is located to enclose in the section the dielectric while being enclosed by the shield. The contact sleeve is mechanically linked with the jacket of the coaxial cable by an extrusion coating so that the extrusion coating serves to relieve the strain on the contact area of the subsection with the shield.

### FIELD OF THE INVENTION

The present invention relates to a coaxial cable, e.g., for the shielded transmission of high-frequency signals, and a method for manufacturing such a coaxial cable.

### BACKGROUND INFORMATION

Coaxial cables are often used for transmitting high-frequency antenna signals in motor vehicles and are mostly used in large quantities in this application. A simple construction and a simple preparation are considered to be important factors for the cost-effective provision of corresponding coaxial cables.

Frequently, plug connectors are installed at the ends of the cable. In this connection, normally a strain relief must be provided, which protects the electrically effective contacts between the plug connector components and the wires against excessive mechanical tensile loads. For this purpose, crimp connections are frequently used, for example.

European Published Patent Application No. 0 118 168 describes a plug connector for a multipole shielded cable, in which a sleeve for establishing contact with a braided shield is pushed into the interior of the tube-shaped braided shield. For mechanical fastening or for the purpose of strain relief, a crimp connection is produced by using another separate outer sleeve.

U.S. Pat. No. 4,131,332 describes a plug connector for a monopole coaxial cable, in which the shield in the form of a metal braid is also contacted on its inner side by a sleeve. Another sleeve is situated on the outside of the shield, which is to ensure a mechanical strain relief of the contact point by a crimp connection.

Conventional cables may have, among other things, the disadvantage that they are comparatively expensive to produce and are made up of relatively many component parts.

### SUMMARY

Example embodiments of the present invention may provide a coaxial cable, which may be produced at a low manufacturing expenditure, and which may exhibit a high quality and robustness. A cost-effective method for manufacturing and preparing such a coaxial cable may also be provided.

According to an example embodiment of the present invention, a contact sleeve is pushed or inserted between a shield and a dielectric when attaching a plug connector that forms one end of a coaxial cable. For this purpose, the contact sleeve is situated such that, in one segment, it encloses the dielectric and is enclosed by the shield. For the purpose of strain relief, an extrusion coating is performed. In this manner, it is possible to do without a crimp connection or other additional measures of strain relief between the shield and the contact sleeve.

The outer contour of the extrusion coating may exhibit different distances with respect to a core of the coaxial cable such that forces may be applied in a form-locking manner via this outer contour onto the housing of a secondary locking mechanism.

In the following, the term enclosed should not be understood to require that a layer which encloses another layer in the cable buildup necessarily touches the other layer. Rather, between two layers, one of which encloses the other, an intermediate layer may also be situated.

In the following, plug connectors should be understood as electrical couplings, which may take the form of plugs as well as sockets.

According to an example embodiment of the present invention, a monopole coaxial cable includes a core; a dielectric enclosing the core; an electrically conductive shield enclosing the dielectric, the shield including a metal braid and an electrically conductive foil; a jacket enclosing the shield; and a plug connector including a contact sleeve, a segment of the sleeve electrically conductively contacting the shield and including a circumferential cutting edge. The sleeve is arranged so that the segment encloses the dielectric and is enclosed by the shield, an inner surface of the segment slid onto an outer surface of the dielectric to widen the jacket in a region of the segment, the cutting edge arranged between the dielectric and the foil. The sleeve is mechanically connected to the jacket by an extrusion coat of an insulating material, the extrusion coat arranged as a strain relief between the segment and the shield.

According to an example embodiment of the present invention, a method for manufacturing a monopole coaxial cable including a dielectric, a shield that includes a metal braid and an electrically conductive foil, and a jacket surrounding the shield, and including a plug connector arranged at one end of the coaxial cable, includes: inserting a contact sleeve, including a segment having a circumferential cutting edge, in an axially parallel direction between the foil and the dielectric, an inner surface of the segment sliding on an outer surface of the dielectric to widen the jacket in a region of the segment, an outside of the segment in a region of the cutting edge sliding along the foil, the segment enclosing the dielectric and enclosed by the shield, the segment electrically contacting the shield; and extrusion coating the jacket and a portion of the sleeve with an insulating material to fix the sleeve relative to the shield as a strain relief.

Further details and aspects of example embodiments of the present invention are described in more detail below in the following description with reference to the appended Figures.

### BRIEF DESCRIPTION OF THE DRAWINGS

FIG. 1 is a longitudinal cross-sectional view of a coaxial cable in a first manufacturing step.

FIG. 2 is a longitudinal cross-sectional view of the coaxial cable in a second manufacturing step.

FIG. 3a is a longitudinal cross-sectional view of the finished coaxial cable.

FIG. 3b is a front view of the finished coaxial cable.

### DETAILED DESCRIPTION

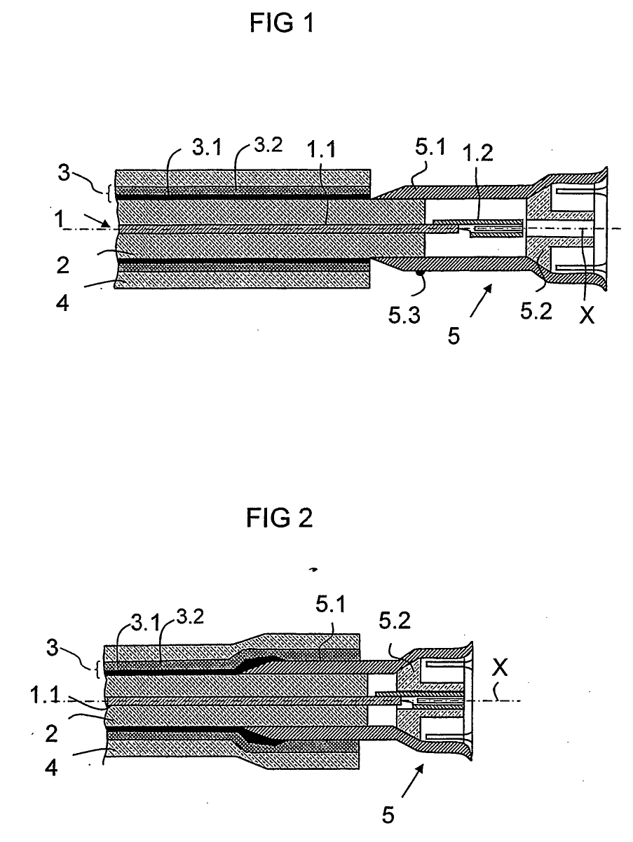

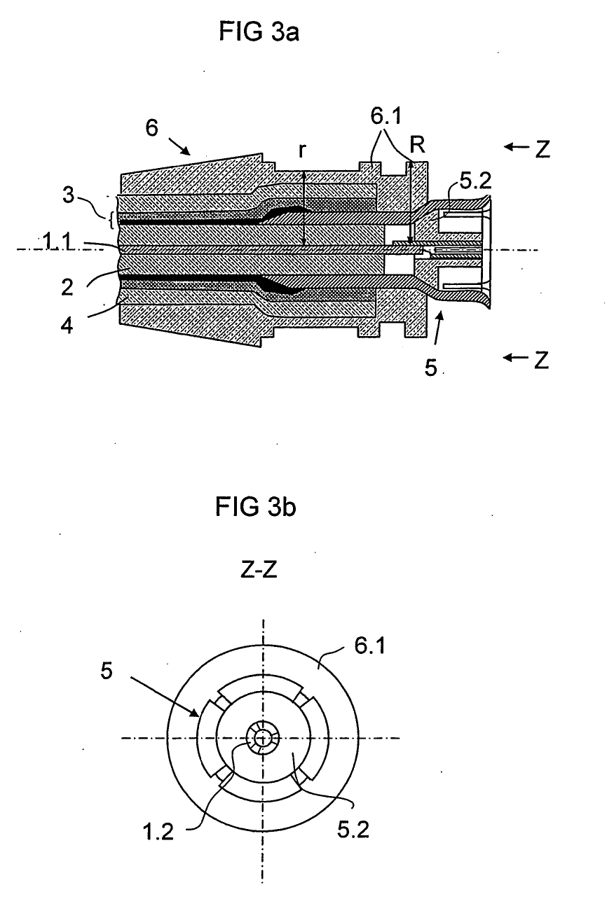

FIG. 1 is a longitudinal cross-sectional view of a coaxial cable at the beginning of manufacture. The monopole coaxial cable has a core 1, which includes an inner lead 1.1 and an inner contact 1.2. Inner lead 1.1 includes seven wires and is enclosed by an electrically nonconductive dielectric 2. This dielectric 2 is enclosed by a shield 3, two-layer shield 3 including an electrically conductive foil 3.1, made of aluminum in the exemplary embodiment illustrated and a metal braid 3.2. These two layers of shield 3 are enclosed by a jacket 4, which represents at the same time the outer layer of the coaxial cable and is made of a PVC-based material. Prior to the attachment of a plug connector, shield 3 and jacket 4 are cut to length such that dielectric 2 protrudes with respect to shield 3 and jacket 4. Furthermore, inner lead 1.1 protrudes from dielectric 2.

First, a mechanical and electrical contact is established between inner contact 1.2 and protruding inner lead 1.1 using a crimp connection. Due to the nature of the cross-sectional views, plastically deformed holding arms of inner contact 1.2 which partially embrace inner lead 1.1 are not visible.

The plug connector, e.g., a socket in the exemplary embodiment illustrated, includes a one-piece electrically conductive contact sleeve 5 made of metal, which is made, among other things, of an essentially hollow cylindrical segment 5.1, the outer surface 5.3 of which is roughened by placing prick-punched points. Alternatively, roughening may also be performed by notching, ribbing or knurling, etc. Furthermore, contact sleeve 5 has a widened subsection, into which a plug may be inserted following assembly. An insulator 5.2 made of plastic is located within the widened subsection. The wall thickness of contact sleeve 5 decreases toward the end that is located across from the widened subsection. This conical form, which is achieved by a beveled turning of the outer surface of the corresponding end of contact sleeve 5, results there substantially in a ring-shaped circumferential cutting edge.

In the course of the assembly or the preparation of the coaxial cable, contact sleeve 5 is slid onto the protruding dielectric 2. For this purpose, the inner diameter of contact sleeve 5 is dimensioned in the corresponding contact area such that contact sleeve 5 may be shifted radially without play on dielectric 2 in the axially parallel direction X.

Subsequently, contact sleeve 5 is pushed in or inserted in the axially parallel direction X between shield 3 and dielectric 2. In the process, the inner surface of the first segment 5.1 of contact sleeve 5 slides on the outer surface of dielectric 2 such that dielectric 2 acts as a guide for sliding contact sleeve 5. The outside of segment 5.1 of contact sleeve 5 slides along foil 3.1, foil 3.1 being partially pushed together as a consequence of the shearing forces produced.

Metal braid 3.2 and jacket 4 are slightly flared in the respective region. This deformation produces radially directed forces that press shield 3 against contact sleeve 5 such that foil 3.1 or metal braid 3.2 securely contact contact sleeve 5 in an electrically conductive manner. Furthermore, the roughened areas or prick-punched points of the outer surface of segment 5.1 of contact sleeve 5 achieves a higher holding or pull-off force of contact sleeve 5.

The use of smooth foil 3.1 as a component of shield 3 may provide for a convenient and simple insertion of contact sleeve 5 with respect to shield 3. Foil 3.1, however, may provide advantages not only with respect to assembly, but is also provided in the cable structure to act as an additional shield attenuation in the operation of the coaxial cable.

The measures described above, e.g., the protrusion of dielectric 2 and the use of foil 3.1 as contact layer with respect to contact sleeve 5, may simplify assembly and may significantly reduce assembly time.

Following the insertion of contact sleeve 5 between shield 3 and dielectric 2, contact sleeve 5, as illustrated in FIG. 2, thus encloses dielectric 2 in a segment 5.1 while being enclosed by shield 3. In this exemplary embodiment, contact sleeve 5 contacts both metal braid 3.2 as well as foil 3.1.

In addition, sliding contact sleeve 5 in the X direction also inserts inner contact 1.2 into the central bore hole of insulator 5.2.

In the next manufacturing step, an injection molding process is used to apply an insulating material, in the illustrated exemplary embodiment, a fiberglass-reinforced PP material, as extrusion coat 6 around jacket 4 and contact sleeve 5. In the process, extrusion coat 6 adheres excellently to contact sleeve 5 made of metal and jacket 4 which, as already described, is based on a PVC material. After cooling extrusion coat 6, a very good mechanical bond of the extrusion-coated parts may be achieved such that extrusion coat 6 acts as a strain relief of the contact between segment 5.1 and shield 3 or that contact sleeve 5 is fixed relative to shield 3 in the sense of a strain relief. For this reason it is not considered to be necessary to provide any other measure or device for strain relief. For example, a crimp connection may be dispensed with in this location, which may markedly decrease the assembly time and at the same time may reduce the number of the parts of the coaxial cable, which may significantly reduce the total expenditure for manufacturing a coaxial cable having a plug connector.

Extrusion coat 6 is geometrically designed such that ribs 6.1 extending around the outside are provided. The outer contour of extrusion coat 6 accordingly has in places offset in the axially parallel direction X different distances r, R with respect to inner lead 1.1 or to core 1. In the illustrated exemplary embodiment, extrusion coat 6 acts not only as a strain-relief element, but also for receiving a housing. Such a housing is used in order to keep a connection of two plug connectors securely together. For this purpose, axially parallel forces (parallel with respect to X) should be able to be introduced into the respective cables. These forces are transmitted by keyed connection between a housing of a secondary locking mechanism and extrusion coat 6. Ribs 6.1 are thus used for the form-locking transmission of axially parallel forces, the connection between the housing and the coaxial cable being torsion-free.

Such a coaxial cable having a plug connector may be particularly suited for use in motor vehicles for transmitting high-frequency signals such as antenna signals, for example, in the range of 4 GHz. Due to the construction, e.g., due to the sealing and mechanically stress-resistant extrusion coating, the coaxial cables may be especially robust and of high quality.

It should be understood that example embodiments of the present invention are not limited to coaxial cables whose plug connectors are oriented in extension of core 1 or along axis X, but it also include coaxial cables having an angled plug connector.

1-11. (canceled)

12. A monopole coaxial cable, comprising:
a core;
a dielectric enclosing the core;
an electrically conductive shield enclosing the dielectric, the shield including a metal braid and an electrically conductive foil;
a jacket enclosing the shield; and
a plug connector including a contact sleeve, a segment of the sleeve electrically conductively contacting the shield and including a circumferential cutting edge;
wherein the sleeve is arranged so that the segment encloses the dielectric and is enclosed by the shield, an inner surface of the segment slid onto an outer surface of the dielectric to widen the jacket in a region of the segment, the cutting edge arranged between the dielectric and the foil; and
wherein the sleeve is mechanically connected to the jacket by an extrusion coat of an insulating material, the extrusion coat arranged as a strain relief between the segment and the shield.

13. The coaxial cable according to claim 12, wherein the extrusion coat adheres to the sleeve and to the jacket.

14. The coaxial cable according to claim 12, wherein the sleeve is a unitary piece.

15. The coaxial cable according to claim 12, wherein an area of an outer surface of the segment is roughened.

16. The coaxial cable according to claim 12, wherein an outer contour of the extrusion coat includes, in locations offset in an axially parallel direction, different distances with respect to the core to form-lockingly transmit forces having an axially parallel directional component onto a housing of a secondary lock mechanism.

17. A method for manufacturing a monopole coaxial cable including a dielectric, a shield that includes a metal braid and an electrically conductive foil, and a jacket surrounding the shield, and including a plug connector arranged at one end of the coaxial cable, comprising:
inserting a contact sleeve, including a segment having a circumferential cutting edge, in an axially parallel direction between the foil and the dielectric, an inner surface of the segment sliding on an outer surface of the dielectric to widen the jacket in a region of the segment, an outside of the segment in a region of the cutting edge sliding along the foil, the segment enclosing the dielectric and enclosed by the shield, the segment electrically contacting the shield; and
extrusion coating the jacket and a portion of the sleeve with an insulating material to fix the sleeve relative to the shield as a strain relief.

18. The method according to claim 17, further comprising cutting the shield and the jacket to length before the inserting step so that the dielectric protrudes with respect to the shield and the jacket.

19. The method according to claim 17, wherein the extrusion coating is performed with an injection molding process.
